(19) United States
(12) Patent Application Publication
(10) Pub. No.: US 2005/0191517 A1
(43) Pub. Date: Sep. 1, 2005

(54) Separator and direct methanol type fuel cell therewith

(76) Inventors: Kunihiko Shimizu, Miyagi (JP); Toshihiko Nishiyama, Miyagi (JP); Takashi Mizukoshi, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/066,861

(22) Filed: Feb. 25, 2005

(30) Foreign Application Priority Data
Feb. 26, 2004 (JP) 2004-051165

(51) Int. Cl. B32B 15/00

(52) U.S. Cl. 428/681; 429/34

(57) ABSTRACT

An objective of this invention is to reduce an electric resistance in a separator and to improve its corrosion-resistance, mechanical strength and sealing performance, that leads to improve a fuel cell output and prevent deterioration in a direct methanol type fuel cell with a planar stack structure. The above objective is achieved by using a separator comprising a clad material consisting of a low-resistance material and an anti-corrosive material coating at least the front and the rear surfaces of the low-resistance material, wherein an area except an electric connection on the clad material is coated with an insulating coating layer.

### BACKGROUND OF THE INVENTION

1. Field of the Invention

This invention relates to a separator as a component of a fuel cell. In particular, it relates to a separator suitable for a direct methanol type fuel cell with a planar stack structure and a direct methanol type fuel cell therewith.

2. Description of the Prior Art

A fuel cell is substantially an electric generator, which generates electricity utilizing a reverse reaction of electrolysis of water. Furthermore, it can generate electric energy with a higher efficiency than a conventional power generating method. Thus, for resource saving, there have been various technical developments for using it in practical applications.

A basic structure of a fuel cell comprises an electrolyte membrane passing hydrogen ions; a membrane electrode assembly (hereinafter, referred to as an “MEA”) where electrode layers comprising a fuel electrode catalyst and an oxygen electrode catalyst disposed in both sides of an electrolyte membrane are joined together; and a separator as a collector drawing electricity from an electrode whereby feeding lines of a fuel and air are separated from each other, the above component is delimited as a cell unit, and cell units are electrically connected.

Fuel cells may be categorized into a fused carbonate type, a solid oxide type, a phosphate type and a solid polymer type, depending on a kind of a material constituting an electrolyte membrane. One of the properties determining an application of such a fuel cell is an operation temperature. Particularly, a solid polymer type fuel cell has attracted attention because of its operating temperature as low as around room temperature (about 25° C.) and is probably applicable to mobile devices.

Furthermore, a fuel cell using methanol whose portability is better than hydrogen as a fuel has been developed. Particularly, a direct methanol type fuel cell has attracted attention as a fuel cell capable of responding to size reduction because it has a higher energy density and does not require a reformer.

Japanese Laid-open Patent Publication No. 62-200666 and “Practical use of a fuel cell for a mobile device” (Keitaikiyou Nenryoudenchi no Jitsuyouka), Oct. 30, 2002, Technical Information Institute Co. Ltd. have disclosed a planar stack structure as a configuration of a direct methanol type fuel cell suitable for a mobile application. A planar stack structure may be configured such that oxygen required for a fuel cell reaction is fed by natural inspiration from the air, and can dispense with a flow path and an auxiliary equipment such as a pump and a fan. Such a configuration is, therefore, suitable particularly for a mobile fuel cell requiring size reduction.

Compared with a conventional laminated stack structure, a planar stack structure allows to a flow path in a separator unit to be more easily formed, and processing of a separator is easier, so that a cost can be reduced. Generally, in a fuel cell in a laminated stack structure, a component electrically connecting cells where flow paths for hydrogen or a hydrogen source and oxygen or the air are formed is called as a bipolar plate or separator. In a planar stack structure, a component corresponding to the bipolar plate or separator electrically connects cells, but it may not require forming a flow path. Such a component is, however, also herein called as a separator.

Properties essential for a separator material include a lower electric resistance, corrosion-resistance, higher mechanical strength and sealing performance.

In a separator material used in a fuel cell with a planar stack structure, an electric connection distance between unit cells is longer than that in a conventional laminated stack structure, resulting in more susceptible to an electric resistance of an electrode material. Therefore, an electric resistance of the constituent material for the separator is desirably as low as possible. Examples of such a low-resistance material include copper, aluminum and alloys thereof. These materials, however, have inadequate corrosion-resistance or mechanical strength.

In a chemical reaction in a solid polymer type fuel cell, a fuel electrode generates hydrogen ions, which pass through an electrolyte membrane made of a solid polymer and then react with oxygen in an air electrode to generate water. The hydrogen ions cause increased acidity within the fuel cell. Furthermore, an oxidizer such as HCOOH or HCOH may be generated by a side reaction. A low-resistance material as described above is less anti-corrosive to an acid or oxidizing agent so that it may be eluted and the metal ions may be incorporated into a polymer electrolyte membrane, leading to reduction in an ion conductivity and finally a deteriorated output of the fuel cell.

Examples of a material with higher corrosion-resistance include graphite, carbon and a stainless steel, but these materials have a relatively higher electric resistance. In particular, a higher discharge current may cause reduction in a voltage, leading to a reduced output. Furthermore, graphite and carbon has lower mechanical strength. Therefore, in a planar stack structure to which a larger plane pressure is loaded, a separator must be thicker for ensuring strength, resulting in difficulty in size reduction.

The necessity for ensuring mechanical strength of a separator will be described together with a reason for that for sealing. When a liquid such as methanol is used as a fuel generally in a planar stack structure, sealing is required for preventing fuel leakage. Furthermore, when using a liquid fuel, an electrolyte membrane is in contact with a liquid phase in a fuel electrode side and with a gaseous phase in an air electrode side. Thus, deformation is caused by a difference in a thermal expansion, resulting in deteriorated sealing performance and increase in a contact resistance.

In a direct methanol type fuel cell with a planar stack structure, it is, therefore, necessary to constitute a separator with a material having adequate mechanical strength and joining it with an MEA with a large planar pressure. However, since graphite or carbon described above is brittle and even copper, aluminum or an alloy thereof has inadequate mechanical strength, loading with a planar pressure may cause deformation, whereby a pressure cannot be evenly loaded, leading to difficulty in reduction in a contact resistance.

In other words, a separator for a fuel cell with a planar stack structure is required to have a lower resistance, corrosion-resistance, higher mechanical strength and sealing ability.

Among these properties, for achieving both lower resistance and corrosion-resistance, there has been investigated the use of a material obtained by laminating a low-resistance material and an anticorrosive material by cladding (hereinafter, referred to as a “clad material”) for a separator. For example, Japanese Laid-open Patent Publication No. 2002-358975 has disclosed the use of a clad material obtained by forming a layer made of a highly anti-corrosive material such as titanium, a titanium alloy, nickel, a nickel alloy and a stainless steel on a surface of a low-resistance material such as copper, a copper alloy, aluminum, an aluminum alloy, magnesium and a magnesium alloy.

### SUMMARY OF THE INVENTION

However, it is assumed that the separator disclosed in Japanese Laid-open Patent Publication No. 2002-358975 is used in a fuel cell with a laminated stack structure. It has, thus, found that when it is used in a fuel cell with a planar stack structure, reduction in a battery output may be prevented.

An objective of this invention is, therefore, to reduce an electric resistance in a separator and to improve its corrosion-resistance, mechanical strength and sealing performance, that leads to improve a fuel cell output and prevent deterioration in a direct methanol type fuel cell with a planar stack structure.

According to a first embodiment of this invention, there is provided a separator used in a direct methanol type fuel cell with a planar stack structure, comprising a clad material consisting of a low-resistance material and an anti-corrosive material coating at least the front and the rear surfaces of the low-resistance material, wherein an area except an electric connection on the clad material is coated with an insulating coating layer.

According to a second embodiment of this invention, there is provided the separator as described above, wherein the low-resistance material is selected from the group consisting of copper, aluminum and an alloy thereof.

According to a third embodiment of this invention, there is provided the separator as described above, wherein the anti-corrosive material is a stainless steel.

According to a fourth embodiment of this invention, there is provided a direct methanol type fuel cell having a planar stack structure using the separator as described above.

This invention can reduce an electric resistance in a separator and improve its corrosion-resistance, mechanical strength, and sealing performance, that leads to improve a fuel cell output; and prevent deterioration in a direct methanol type fuel cell with a planar stack structure.

### BRIEF DESCRIPTION OF THE DRAWINGS

FIG. 1 schematically shows a separator in Example 1, where FIG. 1(a) is a general perspective view of the separator, and FIG. 1(b) is a cross-sectional view of a part of the separator.

FIG. 2 schematically shows a part of the fuel cell in Example 1.

FIG. 3 is a graph showing plots of time-voltage relationship when discharging fuel cells prepared in Examples and Comparative Examples.

In the drawings, the symbols have the following meanings; 1: a separator, 2: an opening, 3: screw mounting hole, 4: a low-resistance material, 5a, 5b: an anti-corrosive material, 6: an insulating coating layer, 7: an air-electrode catalytic electrode layer, 8: an electrolyte membrane, 9: a fuel-electrode catalytic electrode layer, 10: an MEA, 11: a stack substrate.

### DETAILED DESCRIPTION OF PREFERRED EMBODIMENTS

A separator according to this invention comprises a clad material consisting of a low-resistance material and an anti-corrosive material coating at least the front and the back surfaces of the low-resistance material, and in the separator, an area except an electric connection on the clad material is coated with an insulating coating layer. Such a separator according to this invention can be suitably used as a separator for a direct methanol type fuel cell with a planar stack structure.

A low-resistance material may be selected from materials with a resistance of 5.0×10⁸ Ω at 25° C. Specific examples include copper, aluminum, magnesium, silver, gold, platinum and alloys thereof.

The inside of the fuel cell is under an acidic and/or oxidizing atmosphere particularly by H⁺ ions generated in an anode reaction:
CH₃OH+H₂O→6H⁺+CO₂+6e⁻
and HCOOH and/or HCOH generated in side reactions. Among the low-resistance materials described above, an inexpensive material such as copper and aluminum is susceptible to corrosion by an acid and an oxidizing substance, and has lower mechanical strength. Thus, it has been difficult to use such a material as a separator material for a direct methanol type fuel cell with a planar stack structure. In this invention, such a low-resistance material can be also utilized. In other words, this invention is particularly effective when copper, aluminum or an alloy thereof as a low-resistance material is used.

An anti-corrosive material may be selected from materials which are resistant to an acid, an oxidizing agent, and an organic solvent such as methanol; for example, titanium, nickel, tungsten, alloys thereof and stainless steels. Among these, a stainless steel can be suitably used. Since these materials have higher mechanical strength, they may contribute to improvement in overall mechanical strength in the separator.

A separator according to this invention has a clad material in which at least the front and the rear surfaces of the low-resistance material is coated with the anti-corrosive material. Such a clad material can be obtained, for example, by sequentially depositing an anti-corrosive material, a low-resistance material and an anti-corrosive material and pressing it into a laminate by cladding methods. The end of the low-resistance material may be coated with the anti-corrosive material or may be exposed.

Thickness of the low-resistance material and the anti-corrosive material in the above clad material may be appropriately selected, in the light of a resistance and a degree of corrosion-resistance of each materials, the type and the properties of a material forming an insulating coating layer described later, and a resistance and mechanical strength of a final separator. Particularly, in the light of achieving a resistance and corrosion-resistance suitable as a separator for a direct methanol type fuel cell with a planar stack structure, the ratio of the thickness of the low-resistance material and the total thickness of the anti-corrosive material is preferably 1:0.1 to 1:10.

In the separator according to this invention, an area except an electric connection on the clad material is coated with an insulating coating layer. Such a configuration can further improve corrosion-resistance. The insulating coating layer acts as a spacer when applying a large pressure for a planar structure, resulting in improved sealing performance.

A material for forming an insulating coating layer is preferably a material showing acid resistance, oxidation resistance, electric insulation and alcohol resistance, more preferably a material showing further improved mechanical strength and water repellency. Examples include polymers including polyolefin polymers such as polyethylene and polypropylene; fluororesins such as polytetrafluoroethylene; polyester resins such as polyethylene terephthalate and phenol resins. Among these, fluororesins such as polytetrafluoroethylene showing particularly higher water repellency is preferable and polytetrafluoroethylene is more preferable.

A distance between adjacent separators is constant in a laminated stack structure while it is not constant but significantly narrower in some area in a planar stack structure. When water as a product in a reaction in a fuel cell enters the narrower area, a voltage difference between cells may cause electrolysis of water, leading to a reduced battery output. In this invention, a clad material is coated with a water-repellent insulating coating layer so that the above problem and thus reduction in a battery output can be prevented.

A clad material can be coated with an insulating coating layer, for example, by electrodepositing and firing the above material. When forming an insulating coating layer using a flexible material at an elevated temperature such as polyethylene, extrusion molding may be employed and a molded material as a sheet can be attached to the clad material and then pressed into a laminate. A thickness of the insulating coating layer may be appropriately selected in the light of a degree of corrosion-resistance of a clad material and of a material forming an insulating coating layer, and corrosion-resistance, mechanical strength and water repellency of a desired separator.

Herein, an area coated with an insulating coating layer is except an electric connection on the clad material. Since an electric connection must be electrical conductive, a battery cannot be obtained when forming an insulating coating layer on it. Examples of an area of an electric connection include a connection with an MEA and a contact electrically connected with an external element.

A area except an electric connection on the clad material can be masked with an insulating coating layer, for example, by conducting electrodeposition while masking the electric connection and then removing the mask; laminating a sheet material in which a part corresponding to the electric connection has been removed, to a clad material; coating a clad material with an insulating coating layer and removing the insulating coating layer formed in the part to be an electric connection by grinding or polishing. Such a method can be appropriately selected, considering the type of a material on which an insulating coating layer is to be formed and a process for forming an insulating coating layer.

A separator according to this invention can have a shape such that the separator acts as a separator for a direct methanol type fuel cell with a planar stack structure. For example, the separator can generally have a folded shape as a separator in Examples described below, comprising openings as flow paths for a fuel and the air and screw mounting holes for screwing as appropriate.

A direct methanol type fuel cell according to this invention is manufactured by sandwiching an MEA with the separators of the present invention as described above to form a planar stack structure. There are no restrictions to elements other than the above separator, e.g., an MEA, but a conventionally used configuration can be employed.

### EXAMPLES

There will be more specifically described this invention by means of Examples with reference to the drawings.

### Example 1

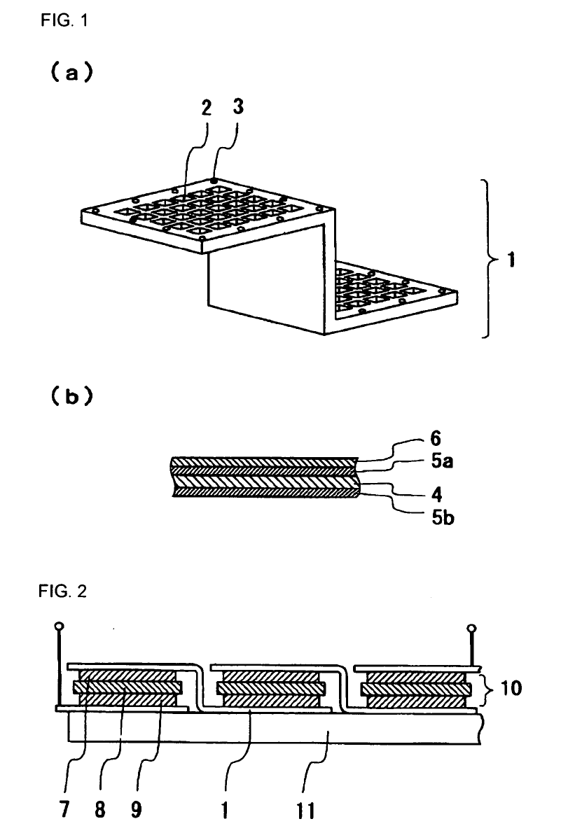

FIG. 1 schematically shows a separator in Example 1, where FIG. 1(a) is a general perspective view of the separator, and FIG. 1(b) is a cross-sectional view of a part of the separator. In these figs, 1 denotes a separator; 2 denotes an opening; 3 denotes a screw mounting hole; 4 denotes a low-resistance material; 5a, 5b denote an anti-corrosive material; and 6 denotes an insulating coating layer. FIG. 1(b) is a cross-sectional view of an area connected to the MEA which is the left part of FIG. 1(a) and the lower surface does not have an insulating coating layer because it is to be connected with the MEA.

In this example, a copper plate (thickness: 0.1 mm) was used as a low-resistance material and a stainless steel plate (thickness: 0.05 mm) was used as an anti-corrosive material. The stainless steel plates were placed on both sides of the copper plate and they were pressed into a clad material, which was then pressed using a mold to give the shape in FIG. 1. Then, openings 2 were formed by punching. The opening 2 may be formed by etching. The openings 2 are to be flow paths for the air or a fuel, and may be formed in a lattice pattern as in this example or alternatively, a full opening may be formed while leaving the fringe of the separator 1.

The insulating coating layer was formed by electrodepositing and firing polytetrafluoroethylene. Polytetrafluoroethylene is suitable for such an application because of its particularly higher water-repellency. Then, the insulating coating layer in the area connected with the MEA and in an electric contact with the outside was removed by grinding or polishing.

In the separator 1 of this example, screw mounting holes 3 were formed in its fringe. The screw mounting holes 3 may be any of those whereby a pressure can be evenly loaded to the MEA without limitations to their inner diameter or number, because they are used when the separator 1 is joined to the MEA.

The separator 1 has the folded shape as shown in the figure for serially and planarly aligning MEAs by alternately sandwiching the MEAs.

There will be described preparation of an MEA for a direct methanol type fuel cell. A catalyst paste was prepared by mixing a solution of a proton-conducting polymer, Nafion® with a platinum catalyst as an air electrode catalyst and a platinum-ruthenium alloy catalyst as a fuel electrode catalyst carried on carbon. The paste was applied on a carbon paper. Then, an air electrode catalytic electrode layer and a fuel electrode catalytic electrode layer were formed, respectively. After sandwiching a polymer electrolyte membrane therebetween, the product was molded by pressing at 130° C. to prepare an MEA. In this example, the polymer electrolyte membrane was Nafion®, a perfluorosulfonic acid polymer from E. I. Dupont.

Then, the MEAs were sandwiched between the separators to prepare a direct methanol type fuel cell with a six-stack serial planar stack structure.

FIG. 2 schematically shows a part of the fuel cell of this example. In FIG. 2, 7 denotes an air electrode catalytic electrode layer; 8 denotes an electrolyte membrane; 9 denotes a fuel electrode catalytic electrode layer; 10 denotes an MEA; and 11 denotes a stack substrate. A fuel tank is built into the stack substrate 11. The fuel cell has a structure where a fuel is fed from the below in the figure while oxygen (the air) is fed from above in the figure by natural inspiration.

### Example 2

A fuel cell was prepared as described in Example 1, except that an aluminum plate (thickness: 0.1 mm) was used as a low-resistance material in a clad material.

### Comparative Example 1

A fuel cell was prepared as described in Example 1, except that a stainless steel plate (thickness: 0.2 mm) was used in place of a clad material to prepare a separator having the shape shown in FIG. 1 without an insulating coating layer.

### Comparative Example 2

A fuel cell was prepared as described in Example 1, except that the clad material as in Example 1 was used to prepare a separator having the shape shown in FIG. 1 without an insulating coating layer.

Evaluation

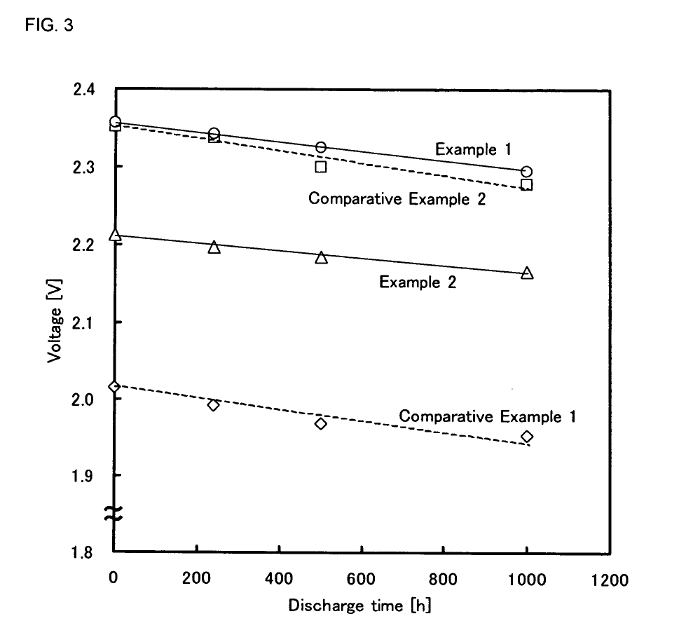

For the fuel cells prepared in the above examples and comparative examples, relationship between a time and a voltage during continuous discharging at 1A is summarized in Table 1. FIG. 3 is a plot of relationship between a time and a voltage. Discharge was performed at 30° C. and a fuel used was a 10 wt % aqueous solution of methanol.

TABLE 1

| | | Initial | After 240 h | After 500 h | After 1000 h |
|---|---|---|---|---|---|
| Example | 1 | 2.356 V | 2.343 V | 2.325 V | 2.296 V |
| | 2 | 2.213 V | 2.197 V | 2.185 V | 2.167 V |
| Comparative | 1 | 2.015 V | 1.992 V | 1.968 V | 1.952 V |
| Example | 2 | 2.351 V | 2.338 V | 2.301 V | 2.279 V |

The results in Table 1 and FIG. 3 indicate that the fuel cells prepared in Examples 1 and 2 have a higher initial voltage and show a reduced decreasing rate in a voltage after 1000 hour discharging, resulting in a less deteriorative fuel cell with an improved output. It is probably because the separators used in Examples 1 and 2 have a lower electric resistance as well as are improved in corrosion-resistance, mechanical strength and sealing performance.

1. A separator used in a direct methanol type fuel cell with a planar stack structure, comprising a clad material consisting of a low-resistance material and an anti-corrosive material coating at least the front and the rear surfaces of the low-resistance material, wherein an area except an electric connection on the clad material is coated with an insulating coating layer.

2. The separator as claimed in claim 1, wherein the low-resistance material is selected from the group consisting of copper, aluminum and an alloy thereof.

3. The separator as claimed in claim 1, wherein the anti-corrosive material is a stainless steel.

4. The separator as claimed in claim 3, wherein the low-resistance material is selected from the group consisting of copper, aluminum and an alloy thereof.

5. A direct methanol type fuel cell having a planar stack structure using the separator as claimed in claim 1.

6. The direct methanol type fuel cell as claimed in claim 5, wherein the low-resistance material is selected from the group consisting of copper, aluminum and an alloy thereof.

7. The direct methanol type fuel cell as claimed in claim 5, wherein the anti-corrosive material is a stainless steel.

8. The direct methanol type fuel cell as claimed in claim 7, wherein the low-resistance material is selected from the group consisting of copper, aluminum and an alloy thereof.

9. A separator for a direct methanol type fuel cell with a planar stack structure, which is constituted by a clad material comprising:
a low-resistance material having a front surface and a rear surface;
an anti-corrosive material covering at least the front and rear surfaces of the low-resistance material and having an electric connection area; and
an insulating coating layer covering the anti-corrosive material except the electric connection area.

10. The separator as claimed in claim 9, wherein the low-resistance material is selected from the group consisting of copper, aluminum and an alloy thereof.

11. The separator as claimed in claim 9, wherein the anti-corrosive material is a stainless steel.

12. The separator as claimed in claim 9, wherein the insulating coating layer is constituted by a polymer selected from the group consisting of polyolefin polymers including polyethylene and polypropylene; fluororesins including polytetrafluoroethylene; polyester resins including polyethylene terephthalate and phenol resins.

13. The separator as claimed in claim 12, wherein the polymer is polytetrafluoroethylene.

14. The separator as claimed in claim 9, which has openings for air or fuel flow on a face where the separator is to be in contact with a membrane electrode assembly.

15. The separator as claimed in claim 14, wherein the openings are formed in a lattice pattern.

16. The separator as claimed in claim 9, which has a fringe area having screw mounting holes for attaching to a membrane electrode assembly.

17. The separator as claimed in claim 9, which has a folded shape having an intermediate portion, a contacting portion for contacting a membrane electrode assembly, and another contacting portion for contacting another membrane electrode assembly, said contacting portion extending nearly perpendicularly from an end of the intermediate portion, said other contacting portion extending nearly perpendicularly from another end of the intermediate portion in a direction opposite to the contacting portion.

18. A direct methanol type fuel cell having a planar stack structure, comprising a membrane electrode assembly, and the separator of claim 9.

19. A direct methanol type fuel cell having a planar stack structure, comprising multiple membrane electrode assemblies, and multiple separators of claim 17, wherein the membrane electrode assemblies are aligned laterally on a plane and sandwiched by the separators.
